(19) United States
(12) Patent Application Publication
(10) Pub. No.: US 2008/0158761 A1
(43) Pub. Date: Jul. 3, 2008

(54) CIRCUIT BREAKER ELECTRONIC TRIP UNIT PERSONALITY MODULE

(76) Inventors: Geoff Butland, Farmington, CT (US); Mark F. Culler, Prospect, KY (US); Nataniel Vicente, Prospect, KY (US); John Dougherty, Collegeville, PA (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/617,949

(22) Filed: Dec. 29, 2006

(51) Int. Cl. H02H 3/08

(52) U.S. Cl. 361/93.2

(57) ABSTRACT

A method and apparatus providing automatic circuit breaker identification to an electronic trip unit including: a mounting plate with mechanical means to releasably engage said electronic trip unit employing a microcontroller; an electronic module embedded in the mounting plate containing a non-volatile memory device, said device containing data identifying the circuit breaker type and ratings, and in operable communication with the electronic trip unit microcontroller, where the microcontroller reads the identification data from the non-volatile memory, the microcontroller is programmed to configure its overcurrent protection algorithms to match the characteristics of the circuit breaker.

### BACKGROUND OF THE INVENTION

Circuit breakers are widely used to protect electrical lines and equipment. The circuit breaker monitors current through an electrical conductor and trips to interrupt the current if certain criteria are met. One such criterion is the maximum continuous current permitted in the protected circuit. The maximum continuous current the circuit breaker is designed to carry is known as the frame rating. However, the breaker can be used to protect circuits in which the maximum continuous current is less than the circuit breaker frame rating, in which case the circuit breaker is configured to trip if the current exceeds the maximum continuous current established for the particular circuit in which it is used. This is known as the circuit breaker current rating. Obviously, the circuit breaker current rating can be less than but cannot exceed the frame rating.

An electronic trip unit (“ETU”) is a device that is used in conjunction with an electromechanical circuit breaker to control the current (or voltage) verses time trip response. The time versus current trip characteristics are, in part, a function of the maximum continuous current permitted by the circuit breaker. This maximum continuous current is also called the current rating of the circuit breaker. As long as the current remains below this maximum continuous current rating, the breaker will remain closed. Momentary low magnitude excursions above the rated current are tolerated; however, persistent overcurrents result in tripping of the breaker. The time delay and generation of the trip signal is an inverse function of the magnitude of the current. For very large magnitude overcurrents, such as would be produced by a fault, the microcontroller is programmed to generate a trip signal instantaneously.

The modification of the Current vs. Trip time response curve is a serious matter. For safety purposes, the circuit breaker and trip unit combination must be properly configured to provide the type of protection judged by the customer or plant engineer to be appropriate. Therefore, the modification to this protection must also be considered to be a very serious event and handled in a way that prohibits errors.

Typically the breaker current rating is defined in two parts. The current sensor installed in the breaker has a rating less than or equal to the frame rating of the breaker. This is referred to as the breaker Sensor Rating. The current rating is further modified by installation of a rating resistor, which is selected to generate a preset voltage when a current proportional to the maximum continuous current permitted in the protected circuit passes through the rating resistor. In order to provide for adjustment of current rating so that the circuit breaker can be used to protect circuits with different maximum continuous currents, it is known to incorporate the rating resistor in a replaceable rating plug, which may be selectively inserted in to the breaker.

Electronic trip circuit interrupters are designed to interrupt overcurrent conditions over a wide range of ampere rating. The current through the protected electric power circuit is continuously sensed by means of current transformers and a voltage signal is supplied to the signal processor within the ETU circuit by means of so-called burden resistor, such as rating resistors in a rating plug. The size of the burden resistor accordingly sets the ampere rating of the corresponding circuit interrupter. A common electronic circuit interrupter can operate over a wide range of ampere ratings by merely changing the value of the burden resistor within the electronic trip rating plug. It is important to prevent an electronic circuit interrupter from being inserted within an electrical distribution circuit for which the circuit interrupter is over-rated. It is perhaps equally important not to insert a circuit interrupter within an electric power distribution circuit for which the circuit interrupter is under-rated as so-called “nuisance tripping” could occur. It is also important to insure that circuit interrupter is not inserted with an electric power distribution circuit with no rating plug or burden resistor whatsoever.

Field replaceable rating plugs are known. These plugs are field installable and may be mechanical for use with thermal-magnetic trip units or may use a combination of analog circuit scaling and digital techniques to change the ETU response. It is typical for these plugs to provide mechanical rejection of plugs that are not suited to certain ranges or frame sizes.

A typical method to prevent incompatible ETU/rating plug combinations includes a first manufacturing process of providing interlocking pins that can be mechanically modified by a secondary manufacturing process of breaking out pieces. The secondary manufacturing process breaks out small pieces of plastic on the housing of the rating plug and complementary pieces on the housing of the ETU.

Current sensors are typically installed as part of the circuit breaker during manufacture. A unique identifying number is assigned to the circuit breaker, which defines the frame rating and sensor rating. The electronic trip unit is configured at the time of manufacture to indicate the frame and sensor ratings of the circuit breaker or circuit breakers with which it is compatible. A unique identifying part number is assigned to the configured trip unit. A specifying engineer orders a specific combination of trip unit and circuit breaker to satisfy the requirements of the power system installation. Appropriate combinations are enforced through mechanical or electronic rejection.

A problem associated with mechanical rejection of plugs and trip units is costs associated with the secondary operation and the limitation of the number of combinations that can be rejected. In some cases the mechanical rejection method is not reliable because some operators, using great force, can insert an incorrect rating plug or install an incorrect trip unit.

A second use for mechanical rejection is in the interface between the trip unit and the circuit breaker mounting point for the trip unit. Trip units are configured, in part, to match the characteristics of the underlying circuit breaker's sensor rating, frame rating, and breaker type. Rejection methods similar to those described for rating plugs are employed to ensure that only a properly matched trip unit can be successfully installed to a circuit breaker. Similarly, mechanical rejection means may be overcome by the application of excessive force, resulting in an invalid and potentially unsafe configuration.

In use, electronic trip units may be exchanged from one circuit breaker to another during the course of maintenance of a power distribution system, or when upgrading the trip unit in a breaker that has been in service for several years, an activity known as “retrofitting”. Newly designed trip units are often required to maintain “backwards compatible” mechanical and electrical interfaces to existing trip systems, sometimes several different trip systems, which adds cost and complexity to new designs.

When retrofitting a new trip unit to an older circuit breaker, the mechanical rejection means employed by the circuit breaker must be carried through to the new trip unit. If the trip unit is intended for use in several different breaker products the number of rejection permutations can be unmanageably large. The specifying engineer may need to properly identify not only the correct breaker, trip unit, and rating plug combinations, but also an appropriate ‘retrofit kit’ in order to upgrade the trip system.

Circuit breakers having electronic trip units are well known in the art. Patented disclosures of such circuit breakers having electronic trip units may be found, for example, in U.S. Pat. Nos. 4,672,501; 66,678,135; and 6,534,991.

Commercially available circuit breakers are constructed to operate for decades in permanent electrical switchgear installations. The systems in which these circuit breakers operate are built to serve the electrical needs of the facility as envisioned at the time of their initial design. However, over time, these initial needs may often change, regulatory imperatives may often force modifications, or advances in protection technology in time may provide compelling reasons to update the switchgear's initial mission. Due to the size and complexity of a typical electrical switchgear installation, and the rugged nature of circuit breakers, it is rarely necessary, or economical, to replace the switchgear or breakers in order to modify or upgrade an electrical system's protection capabilities.

New advances in protection technology may be (and often are) deployed in existing switchgear by upgrading the trip units that control the breakers' operation. These electronic “brains” continually monitor the electrical conditions of the breaker and its attached loads, and will command the breaker mechanism to open if established electrical operating limits are violated.

As indicated above, the problem faced when upgrading circuit breaker trip units is that the mechanical and electrical interface between the circuit breaker mechanism and the trip unit often varies widely from breaker to breaker, even among breakers from the same manufacturer. Additionally, regulatory requirements permit only properly configured trip unit/breaker combinations. Complex mechanical and electronic “rejection” features are in place to prevent the installation of mismatched trip unit/breaker pairs. These rejection features are typically unique to each breaker and trip unit family, with thousands of possible permutations.

When a new trip unit is created and becomes commercially available, i.e., a unit offering newer features and better performance than earlier models, the job of matching the new device to the myriad of existing interfaces is daunting and time consuming. In short, different existing circuit breakers may contain a unique breaker interfaces designed only for that circuit breaker, and trip units designed for that specific unique interface may not be replaced by a trip unit designed for another specific circuit breaker. Presently, dozens of varieties of a basic trip unit may be required in order to satisfy the variety of breaker installations available and desirable for retrofit.

Thus, there are still a number of drawbacks and deficiencies in currently utilized apparatus for circuit breaker technology for which additional technical advances are needed. The method and apparatus described herein address such an advance.

The aspects of the presently described invention will become more readily apparent to the reader with regard to the following figures and detailed description:

### BRIEF DESCRIPTION OF THE FIGURES

FIG. 1 is a generalized depiction of the apparatus, including a depiction of its manufacturing process;

FIG. 2 is a generalize flow diagram depicting a typical trip unit program execution logic;

FIG. 3 is a generalized depiction of the personality module as shown in FIG. 2;

FIG. 4 is a generalized depiction of a conventional circuit breaker with the protective cover removed.

### BRIEF SUMMARY OF THE INVENTION

The invention described herein separates the mechanical and electrical rejection and breaker mounting methods from trip unit functionality through the use of a trip unit personality module, or “TPM”. The TPM described is configured for a specific breaker application, incorporating any unique mechanical mounting requirements and rejection elements. The TPM also includes a non-volatile memory, or “NVM” device that stores information unique to a specified circuit breaker, such as breaker frame size, breaker sensor rating, breaker capability data, neutral position, interrupt rating, agency standard, protection set-points and/or breaker type. In this way the TPM replaces the mechanical rejection features of previous generation trip units with an electronic rejection feature that is common across all of TPM variants.

The TPM invention provides mechanical and electronic interfaces, as well as electronic protocols, that are common to all trip units. In addition, the TPM is permanently fixed as a permanent part of the circuit breaker.

An integral part of this invention is a replaceable trip unit. Rather than creating a unique trip unit for each breaker application, a generic trip unit is created that can be connected to the breaker and TPM to form a complete and integrated system. The trip unit “reads” the configuration data stored on the TPM to determine the TPM identity, what type, make or model circuit beaker neutral position, interrupt rating, agency standard, protection options, set-points and other it is serving. If the TPM identity read from the TPM matches the TPM identity saved in the trip unit NVM, the trip unit uses the options and set-points stored in the trip unit NVM. If the identities do not match, trip unit software configures itself to operate on a default option and set-points and an alarm indication (as, for example, a warning on an LCD display, closing of a contact, or communication warning) will be provided to the user. The user will then be able to re-configure the trip unit on the site to parameters 9options, set-points, frame, sensor, etc) from the TPM. This simplifies the option dispensing requirements for the CM, as it will simply determine the breaker's configuration upon installation by the user.

### DETAILED DESCRIPTION OF THE INVENTION

The above-discussed and other drawbacks and deficiencies are overcome or alleviated by a method and apparatus for automatic identification of the circuit characteristics including: a microprocessor programmed to determine an overcurrent condition of the circuit breaker; a first nonvolatile memory in operable communication with the microprocessor; and an interface module permanently installed to the circuit breaker and releasably engaged with the microprocessor-based trip unit; wherein the interface module may include a second non-volatile memory that can be placed in operable communication with the microprocessor, wherein the microprocessor reads the characteristics of the circuit breaker from the second non-volatile memory, and then accesses a plurality of programs in the first nonvolatile memory based on this characteristic data, and wherein the one of a plurality of programs instructs the microprocessor to modify the Current vs. Time characteristics of the electronic trip unit.

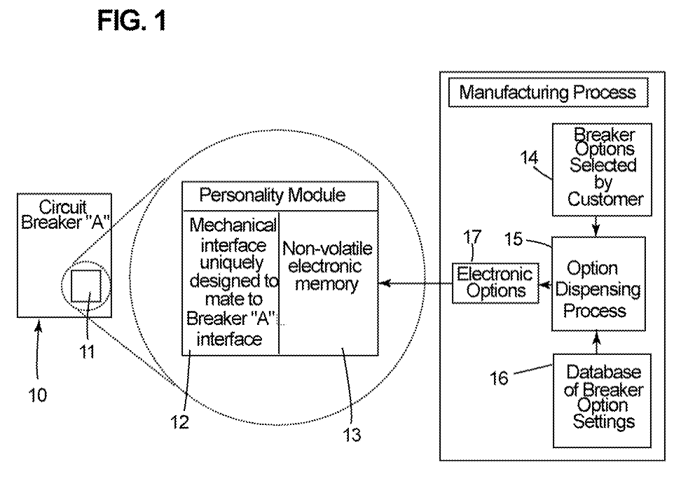

As depicted in FIG. 1, circuit breaker “A” (10) contains the circuit breaker electronic trip unit apparatus (11) or “personality module” or “TPM” according to the present invention. The module is composed of two subunits, a mechanical interface (12) uniquely designed to mate, preferably permanently, with the appropriate interface in breaker (10), and releasably engaged with the microprocessor-based trip unit. In addition to the interface (12), the module (11) further contains non-volatile electronic memory (130 that is in operable communication with the microprocessor within the electronic trip unit (31). The manufacture of such a personality module begins, as depicted in FIG. 1, with the breaker options being selected by the user or customer (14) specific for their individual needs; these options, together with a database of breaker options settings (16) provided by the manufacture specific for a wide variety of conditions are then combined within an option dispensing process (15), and converted into electronic options (17) that are then provided to calibrate the personality module as to its desired parameters.

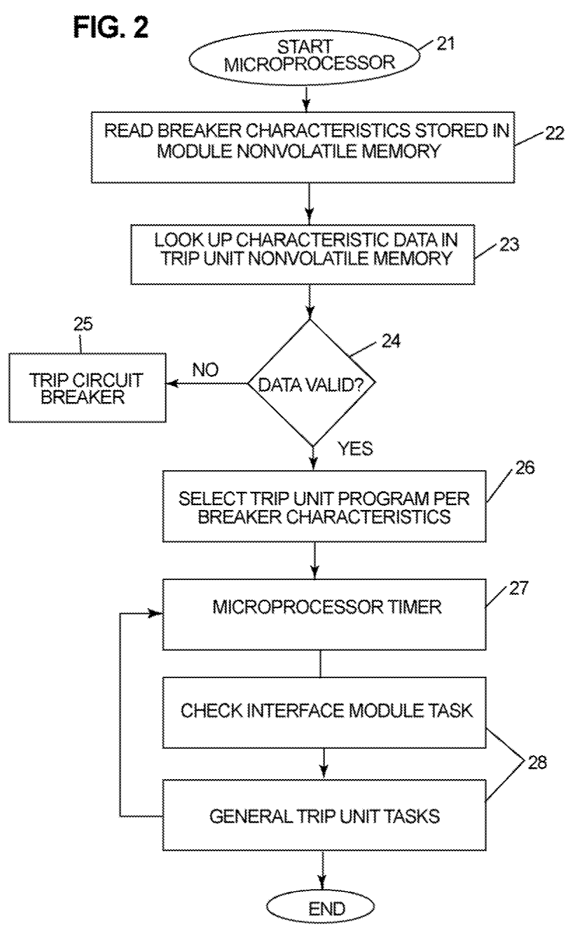

The execution logic utilized by the software within the TPM, is depicted in FIG. 2 and begins with the boot sequence (21) when the microprocessor is first energized and launches its operating system and begins executing program instructions, These instructions include reading (at 22) circuit breaker (10) characteristics stored in the non-volatile memory (13) of the personality module (11); comparing the characteristics data (i.e., TPM identity) (at 23) provided the module during its manufacturing process and stored within the trip unit's non-volatile memory; and determining whether the data (TPM ID and trip unit ID) matches or not. If the microprocessor determines that the identity data matches, then the trip unit will use the options and set-points within its NVM (at 26) and continually to check interface module tasks and general trip unit tasks (at 28) at a predetermined time level (at 27). Such execution logic programs are generally standardized within the industry. If the microprocessor determines the ID's do not match, it will default to save protection options and set-points (it may also provide an alarm and/or LCD display and/or trip the beaker.

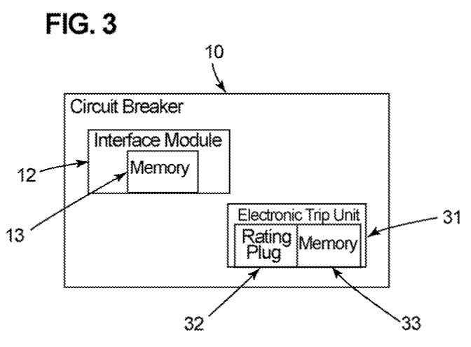

FIG. 3 depicts a generalization the circuit breaker (10) with the interface module (12) according to the present invention with its internal non-volatile memory (13) contained with module (12). Also depicted is a generalization of an electronic trip unit (31) module containing its own non-volatile memory unit (33) together with a removable and replaceable rating plug (32) that is inserted into the trip unit to modify the current rating of the circuit breaker (10).

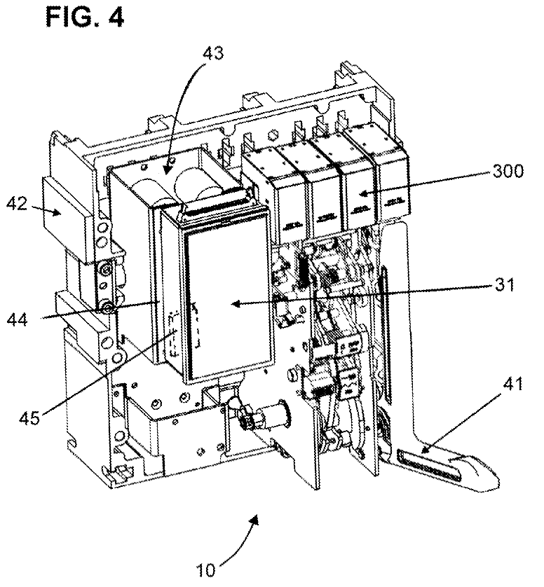

Without its protective cover to isolate the exterior environment from the internal workings and current within the breaker itself, a typical assembled circuit breaker is depicted in FIG. 4. The typical breaker (10) includes a number of mechanical apparatus mounted onto a breaker frame (11) including user installable accessories (300), and a manual trip lever (41) that may be operated by the user to manually allow or halt the flow of electric current through the circuit breaker. Also shown in FIG. 4 is a breaker mounting unit (43) attached to the frame, and attached to the front of the breaker mounting unit (43) is a breaker mounting plate (44) to which the personality module according to the present invention is permanently attached (shown at 45, phantom lines). The electronic trip unit (27) is mechanically and electronically attached to the module.

The personality module according to the present invention offers a number of advantages: first, it divorces the development of new trip units from the development of unique mechanical interfaces thereby allowing the manufacture of a single complex trip unit assembly instead of a number of different specific assemblies; second, a common mechanical and electrical interface is established, paving the way for faster, simpler, and more cost effective upgrades as protection technology advances, or as customer needs change; third, by establishing a consistent electronic rejection method means that future projects will not need to replicate a large number of mechanical rejection methods; and finally, new breaker applications can be realized easily by implementing a universal personality module as depicted, and modifying the software in the within the module as needed.

While we have illustrated and described a preferred embodiment of this invention, it is to be understood that this invention is capable of variation and modification, and we therefore do not wish to be limited to the precise terms set forth, but desire to avail ourselves of such changes and alternations which may be made for adapting the invention to various usages and conditions. Accordingly, such changes and alterations are properly intended to be within the full range of equivalents, and therefore within the purview, of the following claims.

What is claimed:

1. A circuit breaker electronic trip unit apparatus for the identification of circuit breaker characteristics comprising a microprocessor, a first non-volatile memory in operable communication with the microprocessor, and an interface module permanently attached to the circuit breaker.

2. A circuit breaker electronic trip unit apparatus according to claim 1 wherein the microprocessor is programmed to determine an overcurrent condition of the circuit breaker.

3. A circuit breaker electronic trip unit apparatus according to claim 1 wherein the interface module is releasably engaged with the microprocessor-based trip unit.

4. A circuit breaker electronic trip unit apparatus according to claim 3 wherein the interface module includes a second non-volatile memory that can be placed in operable communication with the microprocessor, wherein the microprocessor reads the characteristics of the circuit breaker from the second non-volatile memory, and then accesses a plurality of programs in the first nonvolatile memory based on this characteristic data.

5. A circuit breaker electronic trip unit apparatus according to claim 4 wherein the one of a plurality of programs instructs the microprocessor to modify the Current vs. Time characteristics of the electronic trip unit.
